(19) United States
(12) Patent Application Publication
(10) Pub. No.: US 2014/0073173 A1
(43) Pub. Date: Mar. 13, 2014

(54) ELECTRICAL CONNECTOR

(71) Applicant: Fenny YANG, New Taipei City (TW)

(72) Inventor: Fenny YANG, New Taipei City (TW)

(73) Assignee: ALL BEST ELECTRONICS CO., LTD., (TW)

(21) Appl. No.: 13/606,068

(22) Filed: Sep. 7, 2012

(51) Int. Cl. H01R 13/648; H01R 13/00

(52) U.S. Cl. 439/485; 439/607.01

(57) ABSTRACT

An electrical connector includes a case, and a plurality of ground units and transmission units alternately arranged in the case side by side. The transmission units respectively have a plurality of transmission members and a plurality of ground members for reducing mutual signal interference between the transmission units. Alternatively, at least one coupling unit is coupled to the ground units for reducing mutual signal interference between the transmission units. The ground units, the ground members and the coupling unit provide the function of preventing electromagnetic interference and crosstalk, so that the electrical connector can have increased signal transmission rate. With the above arrangements, the electrical connector also has simplified structure and is easy to assemble.

### FIELD OF TECHNOLOGY

The present invention relates to an electrical connector, and more particularly to an electrical connector having alternately arranged ground units and transmission units as well as coupling units coupled to the ground units to enable upgraded signal transmission rate.

### BACKGROUND

An electrical connector is used to achieve electrical connection between two electronic devices or two electronic interfaces, such as between two circuit boards or between an electronic device and a circuit board, so that data or signal can be transmitted therebetween.

A conventional electrical connector usually has a case, in which a plurality of transmission units and a plurality of ground units are arranged. Each of the transmission units includes a plurality of transmission members for signal transmission. The performance of the electrical connector is influenced by the length, shape and physical properties of the transmission members. Particularly, adjacent conductive terminals in an electrical connector for high-frequency and high-speed transmission tend to affect one another to produce, for example, crosstalk, electromagnetic interference (EMI) or transmission errors. Further, due to the inevitable trend of miniaturization of electrical connector, the length and shape of the conductive terminals as well as the arrangement of conducting path all form very important factors in the structural design of an electrical connector. In assembling the conventional electrical connector, the ground units and the transmission units are sequentially arranged side by side and the ground units are electrically connected to one another to form a ground circuit, so as to reduce the EMI produced by signal terminals during signal transmission.

However, with the arrangements in the conventional electrical connector, it is not able to avoid EMI or crosstalk between adjacent transmission members in the transmission units during signal transmission. In addition, with the ground units and the transmission units sequentially arranged side by side, conducting members must be used to electrically connect the ground units for forming the ground circuit. These conducting members result in complicated structure and troublesome assembling of the conventional electrical connector.

### SUMMARY

A primary object of the present invention is to provide an electrical connector that has simplified structure and is easy to assemble, and has particular structural arrangements to enable enhanced function of preventing EMI and crosstalk, and accordingly increased signal transmission rate.

To achieve the above and other objects, the electrical connector according to a first embodiment of the present invention includes a case, a plurality of ground units arranged in the case, and a plurality of transmission units also arranged in the case. The transmission units respectively have a plurality of transmission members and a plurality of ground members for reducing mutual signal interference between the transmission units.

According to an embodiment of the present invention, the electrical connector further includes a plurality of coupling units; the transmission units and the ground units are alternately arranged in the case, so that the transmission units are respectively located between two ground units; each of the ground members of the transmission units is located between two adjacent transmission members; and the coupling units are coupled to all the ground units and the ground members of the transmission units.

According to an embodiment of the present invention, the ground units respectively have a first carrier plate and a conductive grounding member located in the first carrier plate and having a plurality of first ground coupling heads; the transmission units respectively have a second carrier plate, in which the transmission members and the ground members are located to space from one another; each of the ground members has a second ground coupling head; and the coupling units are coupled to the first ground coupling heads and the second ground coupling heads to thereby electrically connect with the ground members of the transmission units and the conductive grounding members.

According to an embodiment of the present invention, the first carrier plates respectively have a plurality of first notches, and the first ground coupling heads are projected from the first carrier plates to locate in the first notches; and the second carrier plates respectively have a plurality of second notches, and the second ground coupling heads are projected from the second carrier plates to locate in the second notches.

According to an embodiment of the present invention, the case is provided with a plurality of heat outlets, and the heat outlets are located at positions corresponding to the first notches and the second notches.

According to an embodiment of the present invention, the coupling units respectively have a receiving section, a heat transfer section and a passageway; the receiving section provides a row of insertion slots, into which the first ground coupling heads and the second ground coupling heads are fitly inserted; the heat transfer section is used to dissipate heat energy from the electrical connector into ambient air; and the passageway extends a full length of the coupling unit.

According to an embodiment of the present invention, two transmission units are located side by side between two ground units; the conductive grounding member of each ground unit has a plurality of ground terminals; the transmission members of each transmission unit respectively provide a transmission terminal; and the transmission terminals on any two adjacent transmission units are offset from one another and offset from the ground terminals on the ground units.

To achieve the above and other objects, the electrical connector according to a second embodiment of the present invention includes a case, a plurality of ground units arranged in the case, a plurality of transmission units arranged in the case and respectively having a plurality of transmission members, and at least one coupling unit coupled to all the ground units for reducing mutual signal interference between the transmission units.

According to an embodiment of the present invention, the ground units respectively have a first carrier plate and a conductive grounding member located in the first carrier plate and having a plurality of first ground coupling heads; the transmission units respectively have a second carrier plate, in which the transmission members are located to space from one another; and the at least one coupling unit is coupled to the first ground coupling heads.

According to an embodiment of the present invention, the first carrier plates respectively have a plurality of first notches, and the first ground coupling heads are projected from the first carrier plates to locate in the first notches.

According to an embodiment of the present invention, the case is provided with a plurality of heat outlets, the second carrier plates respectively have a plurality of second notches, and the heat outlets and the second notches are located at positions corresponding to the first notches.

According to an embodiment of the present invention, the at least one coupling unit has a receiving section, a heat transfer section and a passageway; the receiving section provides a row of insertion slots, into which the first ground coupling heads are fitly inserted; the heat transfer section is used to dissipate heat energy from the electrical connector into ambient air; and the passageway extends a full length of the coupling unit.

According to an embodiment of the present invention, two transmission units are located side by side between two ground units, the conductive grounding member of each ground unit has a plurality of ground terminals, the transmission members of each transmission unit respectively provide a transmission terminal; and the transmission terminals on any two adjoining transmission units are offset from one another and offset from the ground terminals on the ground units.

In brief, the electrical connector according to the present invention has simplified structure and is easy to assemble. Moreover, with the ground members provided between any two adjacent transmission members in the transmission units, the problem of EMI and crosstalk can be effectively prevented to enable upgraded signal transmission rate of the electrical connector. Further, the ground units and the coupling units also function to transfer heat energy produced by the electrical connector during operation thereof to a circuit board, onto which the electrical connector is inserted, so that the heat energy is dissipated from the circuit board into ambient air to achieve the effect of heat dissipation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a partially exploded perspective view of an electrical connector according to a first embodiment of the present invention;

FIG. 2 is a schematic view of a ground unit for the first embodiment of the electrical connector shown in FIG. 1;

FIG. 3 is a schematic view of a transmission unit for the first embodiment of the electrical connector shown in FIG. 1;

FIG. 4 is a schematic view of another transmission unit for the first embodiment of the electrical connector shown in FIG. 1;

FIG. 5 is a perspective view of a coupling unit for the first embodiment of the electrical connector shown in FIG. 1;

FIG. 6 is a side view of the first embodiment of the electrical connector shown in FIG. 1;

FIG. 7 is a sectional view taken along line A-A of FIG. 6;

FIG. 8 is an assembled perspective view of the first embodiment of the electrical connector shown in FIG. 1;

FIG. 9 is a partially exploded perspective view of an electrical connector according to a second embodiment of the present invention;

FIG. 10 is a schematic view of a transmission unit for the second embodiment of the electrical connector shown in FIG. 9;

FIG. 11 is a schematic view of another transmission unit for the second embodiment of the electrical connector shown in FIG. 9; and

FIG. 12 is a sectional view of the electrical connector according to the second embodiment of the present invention, similar to that of the first embodiment taken along line A-A of FIG. 6.

### DETAILED DESCRIPTION

The present invention will now be described with some preferred embodiments thereof and with reference to the accompanying drawings. For the purpose of easy to understand, elements that are the same in the preferred embodiments are denoted by the same reference numerals.

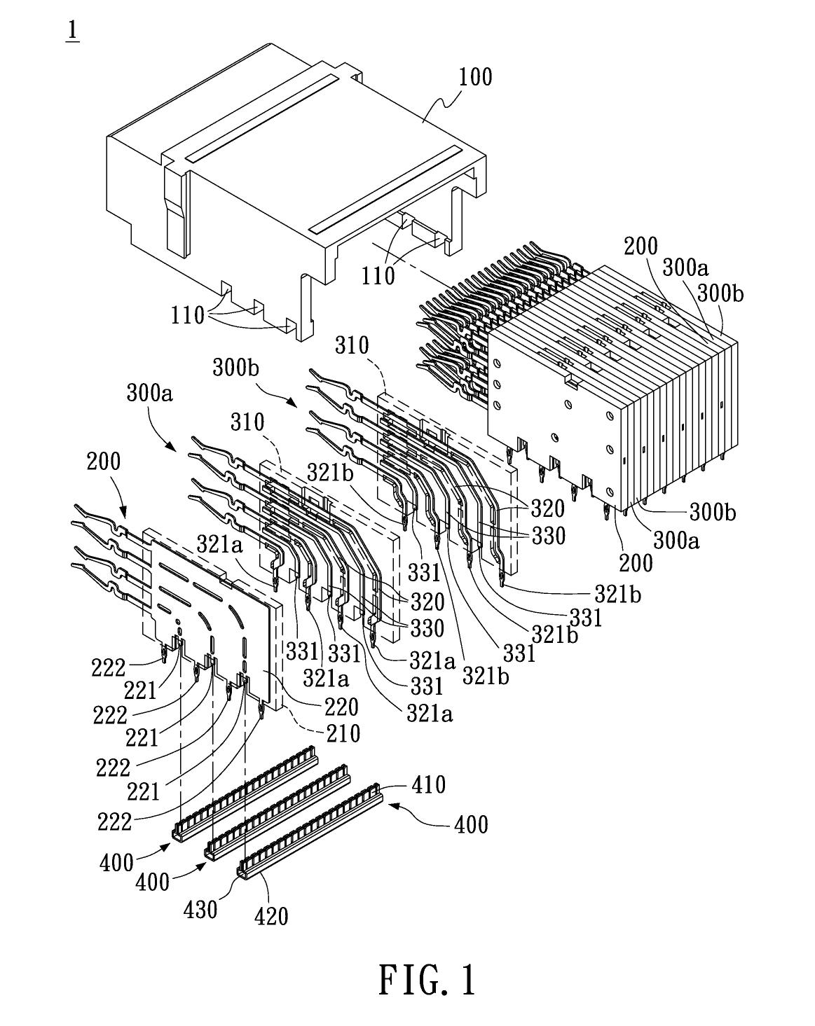

Please refer to FIG. 1 that is a partially exploded perspective view of an electrical connector 1 according to a first embodiment of the present invention. As shown, the electrical connector 1 mainly includes a case 100, a plurality of ground units 200, and a plurality of transmission units 300a, 300b. The ground units 200 and the transmission units 300a, 300b are arranged side by side in a receiving space in the case 100 to together form the electrical connector 1, into which an external transmission cable (not shown) can be plugged for data transmission.

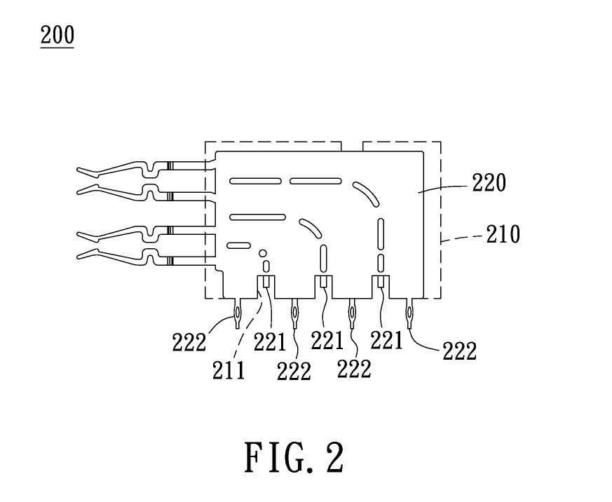

The ground units 200 are arranged in the case 100. As can be seen in FIG. 2, each of the ground units 200 includes a first carrier plate 210 and a conductive grounding member 220 located in the first carrier plate 210. The conductive grounding member 220 includes a plurality of first ground coupling heads 221 and a plurality of ground terminals 222. The ground terminals 222 are projected from one side of the first carrier plate 210 for electrically connecting with a circuit board and other electronic elements or devices.

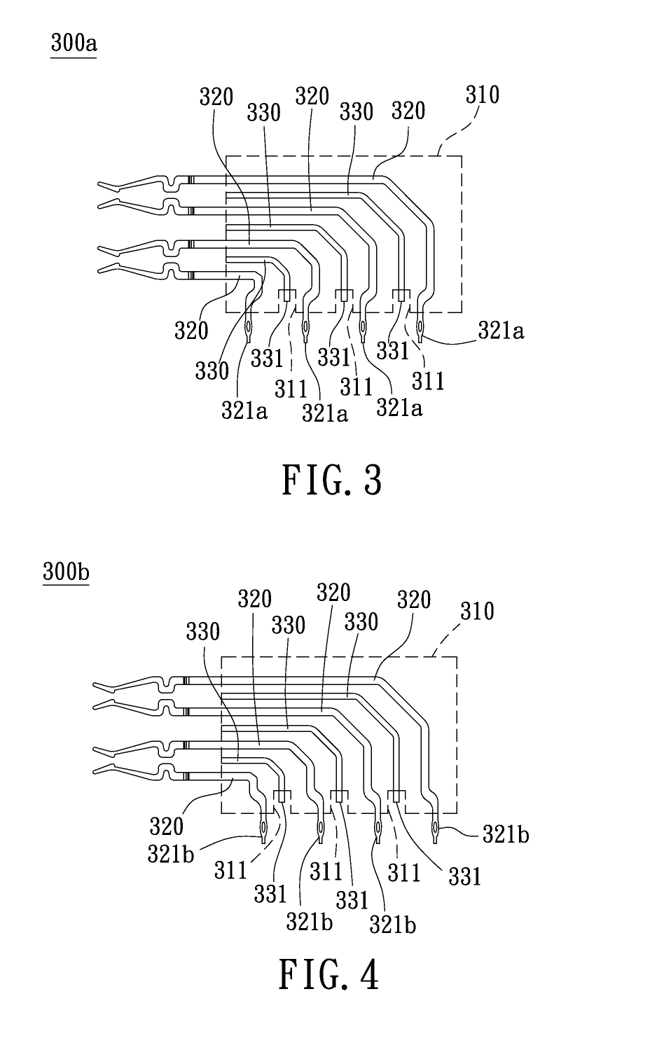

As can be seen in FIG. 1, the transmission units 300a, 300b are arranged in the case 100 to locate at one lateral side of each ground unit 200. As can be seen in FIGS. 3 and 4, each of the transmission units 300a, 300b includes a second carrier plate 310, as well as a plurality of transmission members 320 and a plurality of ground members 330 located in the second carrier plate 310 to space from one another. Each of the ground members 330 is located between two transmission members 320, and has a second ground coupling head 331. The ground members 330 serve to reduce the signal interference between the transmission members 320. The transmission members 320 respectively have a bent body, such that an end of each transmission member 320 is extended from one side of the second carrier plate 310 to project from another adjacent side thereof and form a transmission terminal 321a, 321b for electrically connecting with a circuit board and other electronic elements or devices.

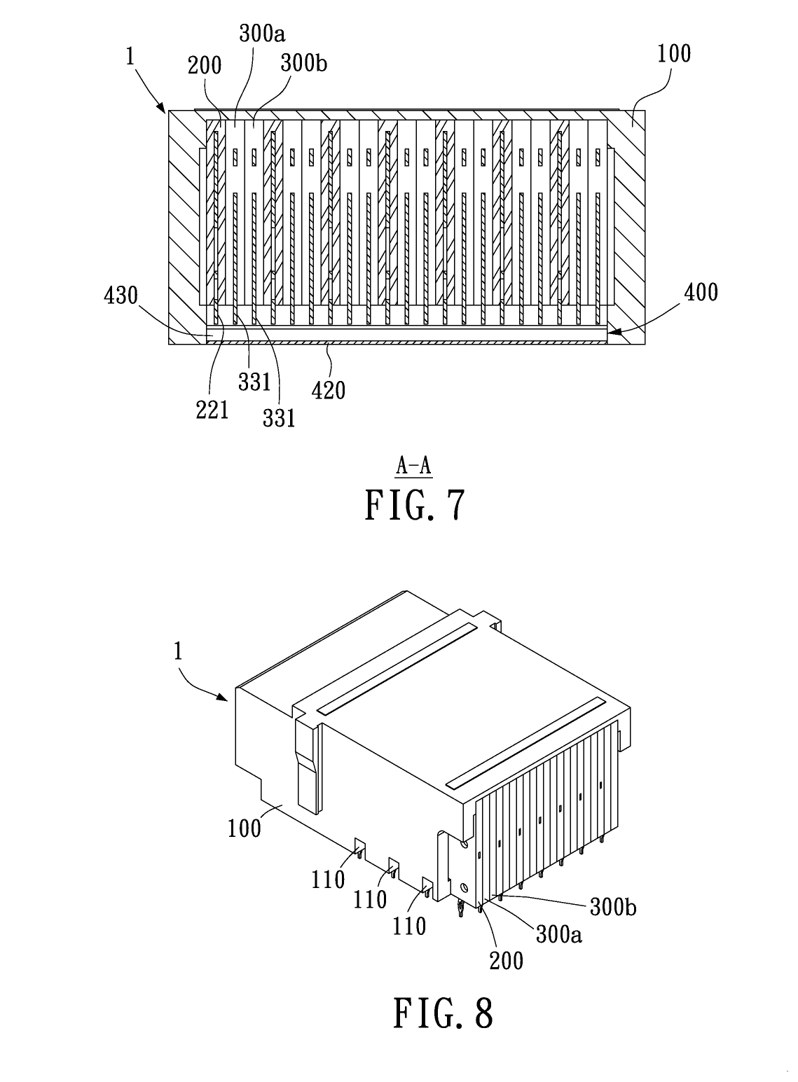

As shown in FIG. 1, in the illustrated first embodiment, there are two transmission units 300a, 300b arranged side by side between two adjacent ground units 200. FIG. 3 shows the transmission members 320 of each transmission unit 300a respectively have a transmission terminal 321a; and FIG. 4 shows the transmission members 320 of each transmission unit 300b respectively have a transmission terminal 321b. It is noted the transmission terminals 321a and the transmission terminals 321b of two adjoining transmission units 300a, 300b are offset from one another; and the ground terminals 222 of the ground units 200 are also offset from the transmission terminals 321a of the transmission units 300a and the transmission terminals 321b of the transmission units 300b. As shown in FIG. 7, the transmission units 300a, 300b and the ground units 200 are arranged in compliance with the standards for relevant electrical connector specifications. It is also understood the present invention is not limited to the illustrated first embodiment but can be modified in design, so that the arrangement of the ground terminals and the transmission terminals can satisfy different electrical connector manufacturing specifications, and the ground members and the ground units can provide the function of preventing EMI and crosstalk.

As shown in FIG. 1, the electrical connector 1 further includes a plurality of coupling units 400, and each of the coupling units 400 is coupled to all the ground units 200 and all the transmission units 300a, 300b. For example, as can be seen in FIG. 7, each of the coupling units 400 is coupled to all corresponding first ground coupling heads 221 and second ground coupling heads 331, so as to electrically connect with the ground members 330 of the transmission units 300 and the conductive grounding members 220 of the ground units 200. Accordingly, the coupling units 400 electrically connect the ground members 330 of the transmission units 300a, 300b to the conductive grounding members 220. The ground members 330 can provide enhanced function of preventing EMI and crosstalk between adjacent transmission members 320 in the transmission units 300a, 300b.

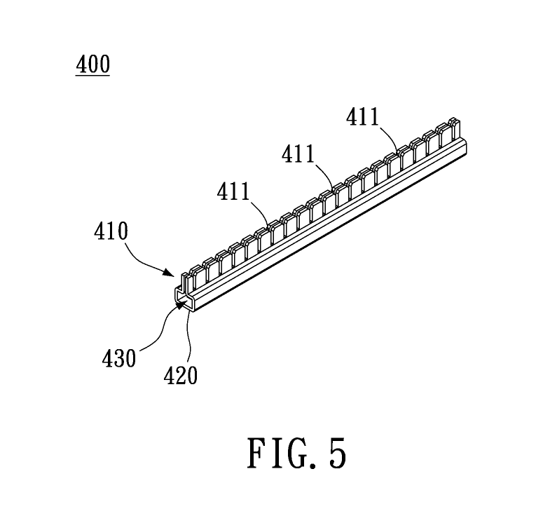

In the illustrated first embodiment, as shown in FIG. 2, the first carrier plate 210 of each ground unit 200 is provided with a plurality of first notches 211, and the first ground coupling heads 221 of the conductive grounding members 220 are projected from the first carrier plate 210 to locate in the first notches 211. On the other hand, as shown in FIGS. 4 and 5, the second carrier plates 310 of the transmission units 300a, 300b respectively have a plurality of second notches 311, and the second ground coupling heads 331 are projected from the second carrier plates 310 to locate in the second notches 311.

In the first embodiment of the present invention shown in FIG. 1, each first carrier plate 210 has three first notches 211, and each second carrier plate 310 has three second notches 311 located corresponding to the three first notches 211. Therefore, when the ground units 200 and the transmission units 300a, 300b are arranged in the case 100 side by side, the first notches 211 on the first carrier plates 210 are aligned with the corresponding second notches 311 on the second carrier plates 310 to together form three transverse recesses for receiving the three coupling units 400 therein. Via the coupling units 400 received in the above-mentioned three transverse recesses, the ground members 330 and the conductive grounding members 220 are electrically connected to one another.

Please refer to FIGS. 1, 6 and 8, the case 100 further includes a plurality of heat outlets 110 symmetrically formed on two lateral sides of the case 100. The heat outlets 110 on the case 100 are located corresponding to the first notches 211 and the second notches 311. When the electrical connector 1 is electrically connected to an external transmission cable (not shown), a part of heat energy produced by the transmission members 320 of the transmission units 300a, 300b during signal transmission is transferred to the coupling units 400 without accumulating in the electrical connector 1, and other part of the produced heat energy is directly dissipated into a space outside the electrical connector 1 via the heat outlets 110 on the case 100. Therefore, the electrical connector 1 can have enhanced heat dissipation effect. According to the present invention, the heat outlets 110 may be in the form of notches or openings without being particularly limited to the shape illustrated in the drawings.

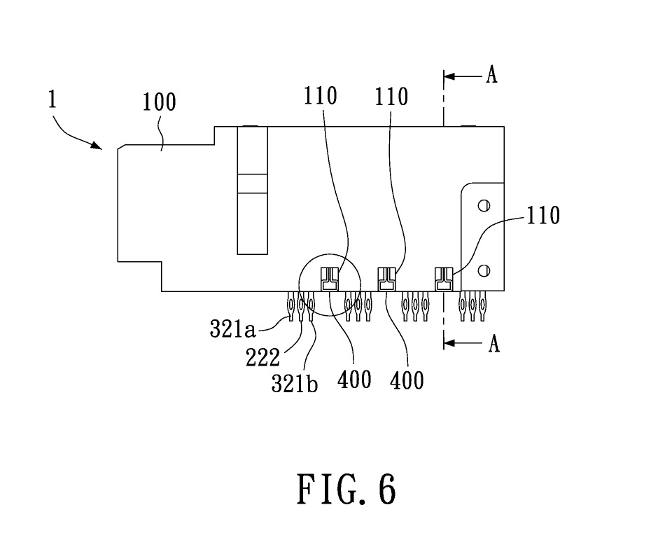

Please refer to FIG. 5. Each of the coupling units 400 includes a receiving section 410, a heat transfer section 420, and a passageway 430. The receiving section 410 provides a row of insertion slots 411, into which the first ground coupling heads 221 and the second ground coupling heads 331 are fitly inserted. The heat transfer section 420 guides the produced heat energy out of the electrical connector 1, so that the heat energy can be dissipated into ambient air. The passageway 430 extends a full length of the coupling unit 400. As can be seen in FIGS. 6 and 7, the passageways 430 are communicable with the heat outlets 110. In the first embodiment, as shown in FIG. 5, each coupling unit 400 is manufactured by bending a metal sheet with good heat conductivity, so as to form a generally rectangular-sectioned passageway 430, which has an upward extended upper side forming the receiving section 410 and a flat lower side forming the heat transfer section 420.

The electrical connector 1 according to the first embodiment of the present invention can be applied to a large number of electrical connectors for use with existing transmission cables of different specifications. In most cases, the only differences between the electrical connectors for use with transmission cables of different specifications are their overall size and the arrangement of the transmission units 300a, 300b. More specifically, the electrical connectors used with transmission cables of different specifications have transmission members different in length and shape, as well as have first and second carrier plates and cases different in shape and size. Nevertheless, all these electrical connectors having different specifications can employ the structure provided by the present invention to include a ground member between any two adjacent transmission members in each transmission unit, and utilize the ground members and the ground units to achieve the effect of EMI protection. Therefore, the scope of the present invention as defined by the appended claims covers electrical connectors of different specifications that employ the above-described arrangements.

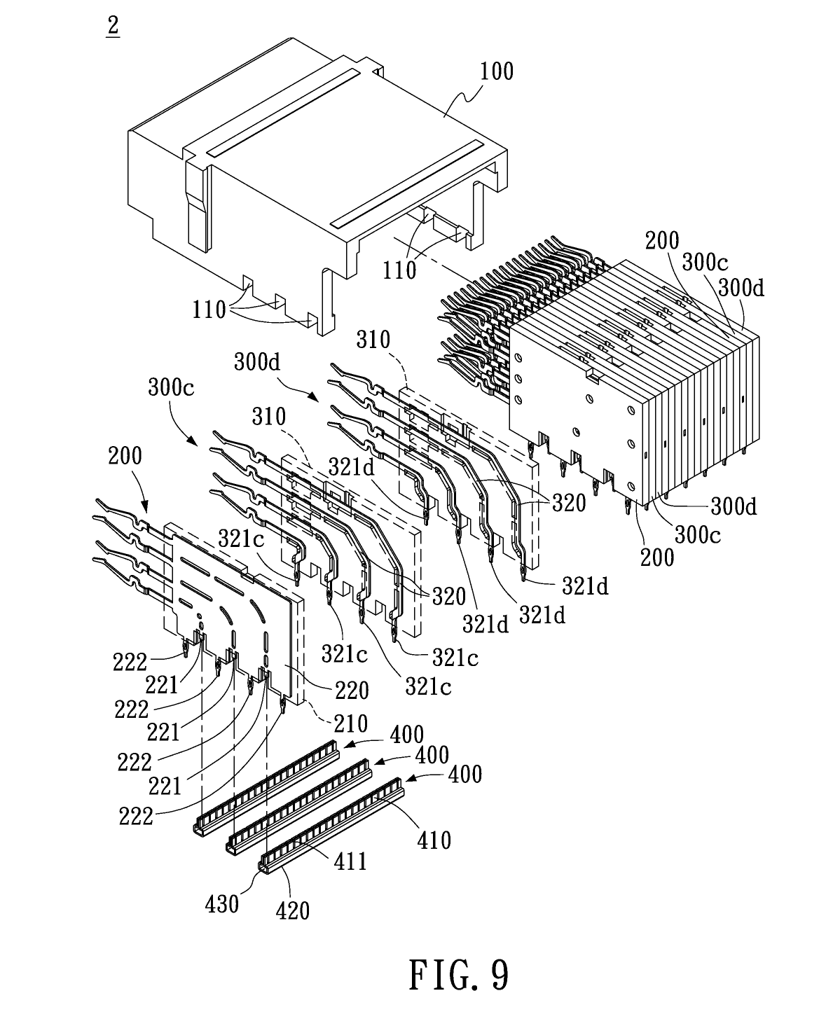

FIG. 9 is a partially exploded perspective view of an electrical connector 2 according to a second embodiment of the present invention. As shown, the electrical connector 2 mainly includes a case 100, a plurality of ground units 200, a plurality of transmission units 300c, 300d, and at least one coupling unit 400.

In the illustrated second embodiment, the ground units 200 and the transmission units 300c, 300d are arranged in a receiving space in the case 100; each of the transmission units 300c, 300d has a plurality of transmission members 320; and three coupling units 400 are provided. Each of the coupling units 400 is coupled to all the ground units 200 for reducing mutual signal interference between the transmission units 300c, 300d.

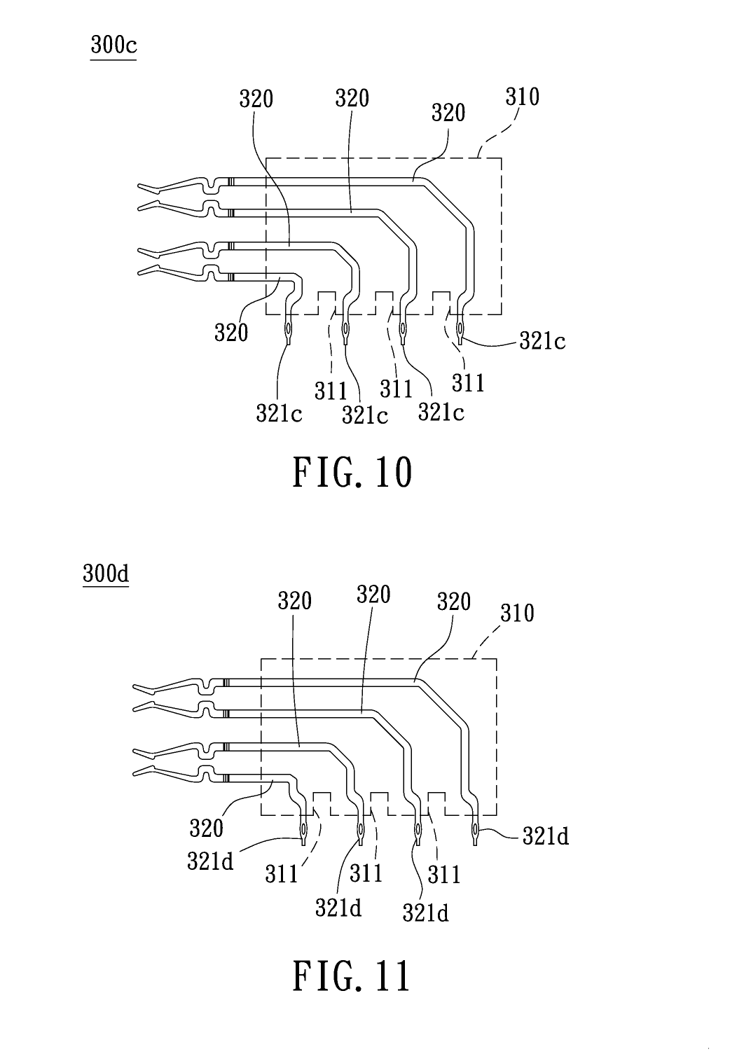

As shown in FIG. 9, the transmission units 300c, 300d are arranged at one lateral side of each ground unit 200, so that there are two transmission units 300c, 300d arranged side by side between two ground units 200. As can be seen in FIGS. 10 and 11, each of the transmission units 300c, 300d includes a second carrier plate 310 and a plurality of transmission members 320 located in the second carrier plate 310 to space from one another. Further, the transmission members 320 respectively have a bent body, such that an end of each transmission member 320 is extended from one side of the second carrier plate 310 to project from another adjacent side thereof and form a transmission terminal 321c, 321d for electrically connecting with a circuit board and other electronic elements or devices.

The ground units 200 are arranged in the case 100. Similar to the ground units for the first embodiment as shown in FIG. 2, the ground units 200 in the second embodiment respectively have a first carrier plate 210 and a conductive grounding member 220 located in the first carrier plate 210 and having a plurality of first ground coupling heads 221.

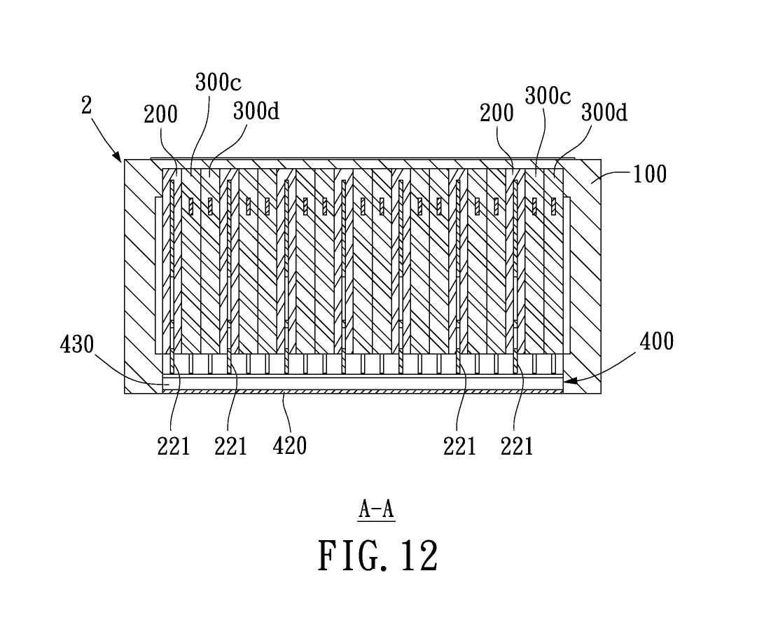

As shown in FIGS. 9 and 12, the coupling units 400 are coupled to the first ground coupling heads 221 to thereby electrically connect with the conductive grounding members 220 of the ground units 200. The ground units 200 sequentially connected to one another by the coupling units 400 can provide the function of EMI protection. Similar to what can be seen in FIG. 2, the first carrier plate 210 of each ground unit 200 in the second embodiment is provided with a plurality of first notches 211, and the first ground coupling heads 221 of the conductive grounding members 220 are projected from the first carrier plate 210 to locate in the first notches 211.

In the second embodiment, as shown in FIGS. 10 and 11, the second carrier plates 310 of the transmission units 300c, 300d respectively have a plurality of second notches 311, and the second notches 311 are located at positions corresponding to the first notches 211 for receiving the coupling units 400 therein.

Please refer to FIG. 9. In the illustrated second embodiment, each first carrier plate 210 has three first notches 211, and each second carrier plate 310 has three second notches 311 located corresponding to the three first notches 211. Therefore, when the ground units 200 and the transmission units 300c, 300d are alternately arranged side by side in the case 100, the first notches 211 on the first carrier plates 210 are aligned with the corresponding second notches 311 on the second carrier plates 310 to together form three transverse recesses for receiving the three coupling units 400 therein. Via the coupling units 400 received in the above-mentioned three transverse recesses, the conductive grounding members 220 are electrically connected to one another.

Further, in the illustrated second embodiment, there are two transmission units 300c, 300d arranged side by side between two adjacent ground units 200. FIG. 10 shows the transmission members 320 of each transmission unit 300c respectively have a transmission terminal 321c; and FIG. 11 shows the transmission members 320 of each transmission unit 300d respectively have a transmission terminal 321d. It is noted the transmission terminals 321c and the transmission terminals 321d of two adjoining transmission units 300c, 300d are offset from one another. And, similar to the first embodiment and what is shown in FIG. 7, the ground terminals 222 of the ground units 200 in the second embodiment are also offset from the transmission terminals 321c of the transmission units 300c and the transmission terminals 321d of the transmission units 300d. Again, in the second embodiment, the transmission units 300c, 300d and the ground units 200 are arranged in compliance with the standards for relevant electrical connector specifications. It is also understood the present invention is not limited to the illustrated second embodiment but can be modified in design, so that the arrangement of the ground terminals and the transmission terminals can satisfy different electrical connector manufacturing specifications.

According to the electrical connector 2 in the second embodiment of the present invention, the case 100 can also be provided with a plurality of heat outlets 110, and the coupling units 400 can respectively include a receiving section 410, a heat transfer section 420, and a passageway 430. Since the heat outlets 110 on the case 100 as well as the receiving section 410, the heat transfer section 420 and the passageway 430 for each coupling unit 400 in the second embodiment are similar to those in the first embodiment, they are not repeatedly described herein.

In brief, the electrical connectors according to the first and the second embodiment of the present invention have simplified structure and are easy to assemble. Moreover, with the ground members provided between any two adjacent transmission members in the transmission units or the coupling units sequentially connecting the ground units to one another, the problem of EMI and crosstalk can be effectively prevented to enable upgraded signal transmission rate of the electrical connectors according to the present invention.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An electrical connector, comprising:
a case;
a plurality of ground units being arranged in the case; and
a plurality of transmission units being arranged in the case; the transmission units respectively having a plurality of transmission members and a plurality of ground members for reducing mutual signal interference between the transmission units.

2. The electrical connector as claimed in claim 1, further comprising a plurality of coupling units; and wherein the transmission units and the ground units are alternately arranged in the case, so that the transmission units are respectively located between two ground units; and wherein each of the ground members of the transmission units is located between two adjacent transmission members; and the coupling units being coupled to all the ground units and the ground members of the transmission units.

3. The electrical connector as claimed in claim 2, wherein the ground units respectively have a first carrier plate and a conductive grounding member located in the first carrier plate and having a plurality of first ground coupling heads; and wherein the transmission units respectively have a second carrier plate, in which the transmission members and the ground members are located to space from one another; and wherein each of the ground members has a second ground coupling head; and the coupling units being coupled to the first ground coupling heads and the second ground coupling heads to thereby electrically connect with the ground members of the transmission units and the conductive grounding members.

4. The electrical connector as claimed in claim 3, wherein the first carrier plates respectively have a plurality of first notches, and the first ground coupling heads being projected from the first carrier plates to locate in the first notches; and wherein the second carrier plates respectively have a plurality of second notches, and the second ground coupling heads being projected from the second carrier plates to locate in the second notches.

5. The electrical connector as claimed in claim 4, wherein the case is provided with a plurality of heat outlets, and the heat outlets are located at positions corresponding to the first notches and the second notches.

6. The electrical connector as claimed in claim 5, wherein the coupling units respectively have a receiving section, a heat transfer section and a passageway; the receiving section providing a row of insertion slots, into which the first ground coupling heads and the second ground coupling heads are fitly inserted; the heat transfer section being used to dissipate heat energy from the electrical connector into ambient air; and the passageway extending a full length of the coupling unit.

7. The electrical connector as claimed in claim 3, wherein two transmission units are located side by side between two ground units, the conductive grounding member of each ground unit has a plurality of ground terminals, and the transmission members of each transmission unit respectively provide a transmission terminal; and the transmission terminals on any two adjoining transmission units are offset from one another and offset from the ground terminals on the ground units.

8. An electrical connector, comprising:
a case;
a plurality of ground units being arranged in the case;
a plurality of transmission units being arranged in the case; the transmission units respectively having a plurality of transmission members; and
at least one coupling unit being coupled to all the ground units for reducing mutual signal interference between the transmission units.

9. The electrical connector as claimed in claim 8, wherein the ground units respectively have a first carrier plate and a conductive grounding member located in the first carrier plate and having a plurality of first ground coupling heads; wherein the transmission units and the ground units are alternately arranged in the case, so that the transmission units are respectively located between two ground units; and wherein the transmission units respectively have a second carrier plate, in which the transmission members are located to space from one another; and the at least one coupling unit being coupled to the first ground coupling heads.

10. The electrical connector as claimed in claim 9, wherein the first carrier plates respectively have a plurality of first notches, and the first ground coupling heads being projected from the first carrier plates to locate in the first notches.

11. The electrical connector as claimed in claim 10, wherein the case is provided with a plurality of heat outlets, and the second carrier plates respectively have a plurality of second notches; and the heat outlets and the second notches are located at positions corresponding to the first notches.

12. The electrical connector as claimed in claim 11, wherein the at least one coupling unit has a receiving section, a heat transfer section and a passageway; the receiving section providing a row of insertion slots, into which the first ground coupling heads are fitly inserted; the heat transfer section being used to dissipate heat energy from the electrical connector into ambient air; and the passageway extending a full length of the coupling unit.

13. The electrical connector as claimed in claim 9, wherein two transmission units are located side by side between two ground units, the conductive grounding member of each ground unit has a plurality of ground terminals, and the transmission members of each transmission unit respectively provide a transmission terminal; and the transmission terminals on any two adjoining transmission units are offset from one another and offset from the ground terminals on the ground units.
